(19) United States
(12) Patent Application Publication
(10) Pub. No.: US 2009/0179584 A1
(43) Pub. Date: Jul. 16, 2009

(54) DC/DC CONVERTER

(75) Inventor: Koichi Miyanaga, Ukyo-Ku (JP)

Correspondence Address: CANTOR COLBURN, LLP, 20 Church Street, 22nd Floor, Hartford, CT, 06103, US

(73) Assignee: ROHM CO., LTD., Kyoto (JP)

(21) Appl. No.: 12/325,550

(22) Filed: Dec. 1, 2008

(30) Foreign Application Priority Data
Nov. 30, 2007 (JP) JP2007-309959

(51) Int. Cl. H05B 41/36; G05F 1/10

(52) U.S. Cl. 315/291; 323/282

(57) ABSTRACT

A first transistor and a second transistor are disposed in series between a first terminal and a ground terminal. A diode is disposed in parallel with the first transistor in a direction such that the cathode thereof will be on the first terminal side. An inductor is disposed between a connection point and a second terminal. A first capacitor is disposed between the first terminal and the ground terminal, and a second capacitor is disposed between the second terminal and the ground terminal. In a first mode, a control unit allows the first transistor and the second transistor to be alternately subjected to a switching operation, so as to lower the voltage of an external voltage Vext of the first terminal and to output the lowered voltage to the second terminal. In a second mode, the control unit turns the first transistor off, and allows the second transistor to be subjected to a switching operation, so as to raise the voltage of a voltage that is input to the second terminal and to output the raised voltage to the first terminal.

### BACKGROUND OF THE INVENTION

1. Field of the Invention

The present invention relates to a technique of controlling a DC/DC converter.

2. Description of the Related Art

On an electronic apparatus of recent years such as a portable telephone, a PDA (Personal Digital Assistant), or a notebook-type personal computer, a secondary battery such as a lithium ion battery and a charging circuit for charging the secondary battery are mounted. FIG. 1 is a block diagram illustrating a configuration of a general electronic apparatus having a secondary battery mounted thereon.

An electronic apparatus 200 includes a secondary battery (hereafter also referred to simply as a battery) 210, a charging circuit 212, a step-up circuit 220, and a load 230. To the electronic apparatus 200, an external power source 240 such as an AC adaptor or a USB power source is connected. The charging circuit 212 charges the battery 210 by using an external voltage Vext from the external power source 240. The step-up circuit 220 raises the voltage of the battery voltage Vbat to generate a power source voltage that is needed for the load 230. When the external power source 240 is connected, the load 230 may be in some cases driven by the external voltage Vext instead of the output voltage of the step-up circuit 220 (See, for example, Japanese Patent Application (Laid-Open) Nos. 2006-34033 and 2007-267582).

Since the electronic apparatus 200 of FIG. 1 includes the charging circuit 212 and the step-up circuit 220 mounted thereon, two systems including a control circuit and a peripheral component will be needed, thereby increasing the occupied area.

### SUMMARY OF THE INVENTION

Certain embodiments of the present invention have been made in view of these circumstances, and a general purpose thereof is to reduce the number of electronic components that are used in an electronic apparatus.

One embodiment of the present invention relates to a control circuit that controls a synchronized rectification type DC/DC converter in which a first voltage is supplied to a first terminal and a power source is connected to a second terminal. The synchronized rectification type DC/DC converter includes a first transistor and a second transistor that are disposed in series between the first terminal and a fixed voltage terminal, an inductor that is disposed between the second terminal and a connection point of the first transistor and the second transistor, and a capacitor that is disposed between the second terminal and the fixed voltage terminal. The control circuit is configured to be capable of switching between a first mode in which the control circuit allows the first transistor and the second transistor to be alternately subjected to a switching operation, so as to lower the first voltage of the first terminal and to output the lowered voltage to the power source connected to the second terminal, and a second mode in which the control circuit receives a voltage from the power source at the second terminal, turns the first transistor off, and allows the second transistor to be subjected to a switching operation, so as to raise the voltage of the power source and to output the raised voltage to the first terminal.

According to this embodiment, the supply of voltage to the power source and the supply of voltage to the load can be realized with one synchronized rectification type DC/DC converter, so that the circuit area and the number of components can be reduced.

The control circuit may operate in the first mode when the first voltage is supplied, and may operate in the second mode when the first voltage is not supplied.

The control circuit may include a control terminal that receives an input of a control signal indicating the switching between the first and second modes.

The power source maybe a battery, and the synchronized rectification type DC/DC converter may function as a charging circuit that charges the battery when the control circuit operates in the first mode.

Another embodiment of the present invention relates to an electronic apparatus. This electronic apparatus includes a battery, a synchronized rectification type step-down DC/DC converter having an input terminal that receives an external voltage and an output terminal to which the battery is connected, and a load connected to the input terminal of the step-down DC/DC converter. The step-down DC/DC converter is configured to be capable of switching between a first mode in which the converter operates as a step-down type switching regulator to charge the battery with the external voltage, and a second mode in which the converter operates as a step-up type switching regulator that raises a battery voltage of the output terminal to output the raised voltage to the input terminal, so as to drive the load.

The electronic apparatus may drive the load with the external voltage in the first mode.

In one embodiment, the load may be a light emitting diode. The electronic apparatus may further include a current source that is disposed on a path of the light emitting diode. The DC/DC converter may perform a step-up operation by feedback so that a voltage (potential difference) across the current source will have a constant value in the second mode.

Another embodiment of the present invention relates to a DC/DC converter. This DC/DC converter includes first and second terminals, a first transistor and a second transistor that are disposed in series between the first terminal and a fixed voltage terminal, a diode that is disposed in parallel with the first transistor in a direction such that a cathode thereof will be on the first terminal side, an inductor that is disposed between the second terminal and a connection point of the first transistor and the second transistor, a first capacitor that is disposed between the first terminal and the fixed voltage terminal, a second capacitor that is disposed between the second terminal and the fixed voltage terminal, and a control unit that controls a state of the first and second transistors. The control unit is configured to be capable of switching between a first mode in which the control unit allows the first transistor and the second transistor to be alternately subjected to a switching operation, so as to lower an external voltage of the first terminal and to output the lowered voltage to the second terminal, and a second mode in which the control unit turns the first transistor off, and allows the second transistor to be subjected to a switching operation, so as to raise a voltage that is input to the second terminal and to output the raised voltage to the first terminal.

It is to be noted that any arbitrary combination or rearrangement of the above-described structural components and so forth is effective as and encompassed by the present embodiments.

Moreover, this summary of the invention does not necessarily describe all necessary features so that the invention may also be a sub-combination of these described features.

### BRIEF DESCRIPTION OF THE DRAWINGS

Embodiments will now be described, by way of example only, with reference to the accompanying drawings which are meant to be exemplary, not limiting, and wherein like elements are numbered alike in several Figures, in which:

FIG. 1 is a block diagram illustrating a configuration of a general electronic apparatus having a secondary battery mounted thereon;

FIG. 2 is a circuit diagram illustrating a configuration of an electronic apparatus according to an embodiment of the present invention; and

FIG. 3 is a block diagram of a driving device that drives a light emitting diode (LED) using the DC/DC converter of FIG. 2.

### DETAILED DESCRIPTION OF THE INVENTION

The invention will now be described based on preferred embodiments which do not intend to limit the scope of the present invention but exemplify the invention. All of the features and the combinations thereof described in the embodiment are not necessarily essential to the invention.

In the present specification, “the state in which a member A is connected to a member B” includes a case in which the member A and the member B are directly physically connected and a case in which the member A and the member B are indirectly connected via another member that does not affect the electric connection state.

Similarly, “the state in which a member C is disposed between a member A and a member B” includes a case in which the member A and the member C or the member B and the member C are directly connected and a state in which they are indirectly connected via another member that does not affect the electric connection state.

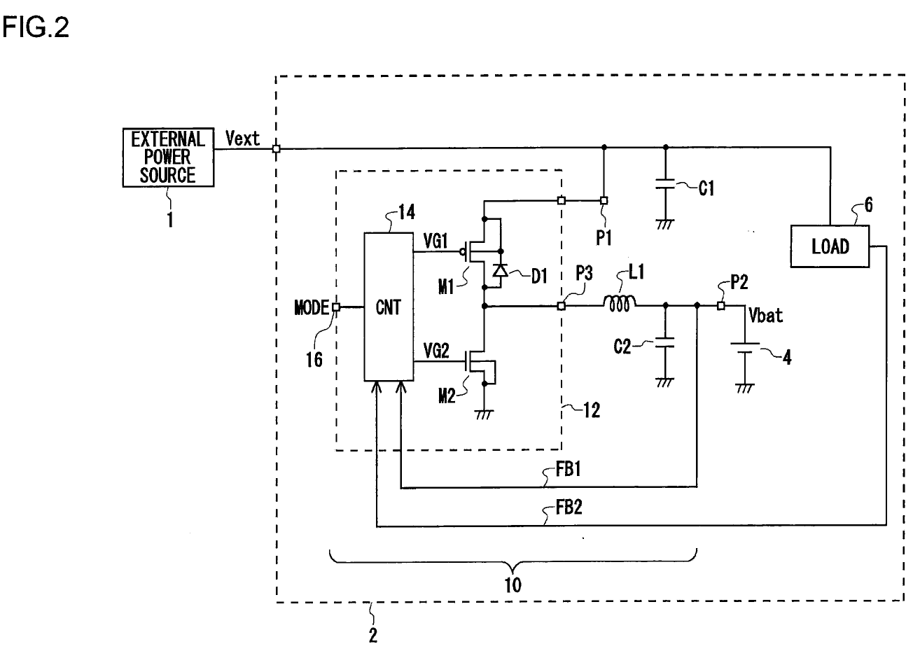

FIG. 2 is a circuit diagram illustrating a configuration of an electronic apparatus 2 according to an embodiment of the present invention. The electronic apparatus 2 is, for example, an information terminal apparatus of battery driving type such as a portable telephone terminal, a PDA, or a notebook-type personal computer. The electronic apparatus 2 includes a battery 4, a load 6, and a synchronized rectification type DC/DC converter (switching regulator) 10. The electronic apparatus 2 raises the voltage (also referred to as the battery voltage) Vbat of the battery 4 and supplies the raised voltage to the load 6. The battery 4 is a secondary battery such as a lithium ion battery or a nickel hydrogen battery. An external power source 1 is connected to the electronic apparatus 2, so as to supply an external voltage Vext. The electronic apparatus 2 charges the battery 4 by using the external voltage Vext.

When the external power source 1 is connected, the external voltage Vext is applied to the first terminal P1 of the DC/DC converter 10. The battery 4 is connected to the second terminal P2 of the DC/DC converter 10.

The DC/DC converter 10 is configured to be capable of switching between at least the following two modes.
1. First Mode

By using the first terminal P1 as an input terminal and the second terminal P2 as an output terminal, the DC/DC converter 10 is operated as a step-down type switching regulator. The DC/DC converter 10 lowers the voltage of the external voltage Vext that is applied to the first terminal P1, so as to generate a charging current for charging the battery 4.
2. Second Mode

By using the second terminal P2 as an input terminal and the first terminal P1 as an output terminal, the DC/DC converter 10 is operated as a step-up type switching regulator. The DC/DC converter 10 raises the voltage of the battery voltage Vbat that is applied to the second terminal P2, so as to supply a driving current for driving the load 6 that is connected to the first terminal P1 side.

The electronic apparatus 2 may directly drive the load with the external voltage Vext in the first mode.

The DC/DC converter 10 includes a charging control circuit 12, an inductor L1, a first capacitor C1, and a second capacitor C2.

The charging control circuit 12 includes a first transistor M1, a second transistor M2, a diode D1, and a control unit 14, which are monolithically integrated on one semiconductor substrate.

The first transistor M1 and the second transistor M2 are disposed in series between the first terminal P1 and a fixed voltage terminal (ground terminal). In FIG. 2, the first transistor M1 is a P-channel MOSFET, and the second transistor M2 is an N-channel MOSFET.

The diode D1 is disposed in parallel with the first transistor M1 in a direction such that the cathode thereof will be on the first terminal P1 side. The diode D1 may be constructed by using the body diode of the first transistor M1. Alternatively, a peripheral discrete element may be disposed between the first terminal P1 and the connection point P3 of the first transistor M1 and the second transistor M2.

The inductor L1 is disposed between the second terminal P2 and the connection point P3 of the first transistor M1 and the second transistor M2. The first capacitor C1 is disposed between the first terminal P1 and the fixed voltage terminal (ground terminal). The second capacitor C2 is disposed between the second terminal P2 and the fixed voltage terminal (ground terminal).

The control unit 14 generates gate voltages VG1 and VG2 of the first transistor M1 and the second transistor M2, so as to control the on-off state of the first transistor M1 and the second transistor M2. The control unit 14 receives at least two feedbacks that are respectively used in the first mode and the second mode. The charging control circuit 12 is provided with a control terminal 16, and receives a mode control signal MODE for switching between the first mode and the second mode from a host processor that is not illustrated in the drawings.

The control unit 14 switches between the first mode and the second mode in accordance with the mode control signal MODE.

In the first mode, the control unit 14 allows the first transistor M1 and the second transistor M2 to be alternately subjected to a switching operation, so as to lower the voltage of the external voltage Vext of the first terminal P1 and to output the lowered voltage to the second terminal P2. In the first mode, a first feedback path FB1 is used. For example, via the first feedback path FB1, the value of the battery voltage Vbat or the charging current that flows through the first transistor M1 and the inductor L1 is fed back to the control unit 14. The control unit 14 controls the time ratio (duty ratio) of the on-off of the first transistor M1 and the second transistor M2 so that the battery voltage Vbat will be approximated to a target value (constant-voltage charging) or the charging current will be approximated to a target value (constant-current charging).

In other words, in the first mode, the first transistor M1 functions as a switching transistor; the second transistor M2 functions as a synchronized rectification transistor; and the second capacitor C2 functions as an output capacitor, so as to perform a voltage-lowering operation. As a method of generating the gate voltages VG1 and VG2 of the first transistor M1 and the second transistor M2 on the basis of the feedback, one may use a known technique such as the pulse width modulation or the pulse frequency modulation, so that the method is not particularly limited.

In the second mode, the control unit 14 allows the second transistor M2 to be subjected to a switching operation in a state in which the first transistor M1 is turned off, so as to raise the voltage of the battery voltage Vbat that is input to the second terminal P2 and to output the raised voltage to the first terminal P1.

In the second mode, a second feedback path FB2 is used. For example, via the second feedback path FB2, a signal indicating a state of the load 6, for example, the voltage of the first terminal P1 that is supplied to the load 6 or the electric current that flows through the load 6, or a signal indicating a state of a circuit that drives the load 6 is fed back to the control unit 14. The control unit 14 controls the time ratio of the on-off of the second transistor M2 so that the amount of electricity that is fed back to the control unit 14 via the second feedback path FB2 will be approximated to a target value.

In other words, in the second mode, the second transistor M2 functions as a switching transistor; the diode D1 functions as a diode for synchronized rectification; and the first capacitor C1 functions as an output capacitor, so as to perform a step-up operation. The driving of the second transistor M2 in the second mode can be realized by a known technique such as the pulse width modulation or the pulse frequency modulation.

The above is the configuration of the DC/DC converter 10 and the electronic apparatus 2.

When the external power source 1 is connected to the electronic apparatus 2 in a state in which the battery voltage Vbat lowers to necessitate charging of the battery 4, the DC/DC converter 10 is set in the first mode. As a result of this, the battery 4 is charged. In this state, the external voltage Vext from the external power source 1 is supplied to the load 6. Therefore, the load 6 may be driven by using the external voltage Vext.

When the external power source 1 is not connected in a state in which the battery 4 is charged, the DC/DC converter 10 is set in the second mode, where the voltage of the battery voltage Vbat is raised. The raised voltage is supplied from the first terminal P1 to the load 6.

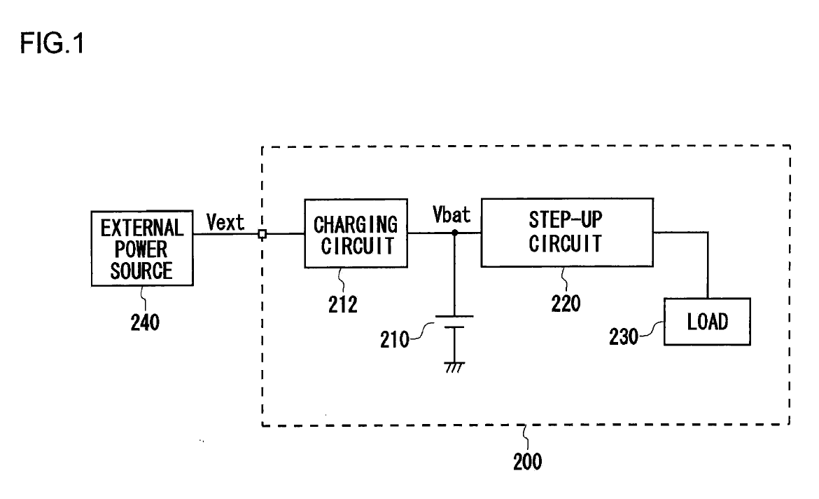

In this manner, according to the DC/DC converter 10 of FIG. 2, the battery 4 can be charged and the voltage of the battery voltage Vbat can be raised to be supplied to the load 6 by using a single switching power source. With the conventional circuit of FIG. 1, the charging circuit and the step-up circuit 220 are individually needed, whereby the circuit area will increase and the number of components will increase. In contrast, by using the DC/DC converter 10 of FIG. 2, the circuit area and the number of components can be reduced.

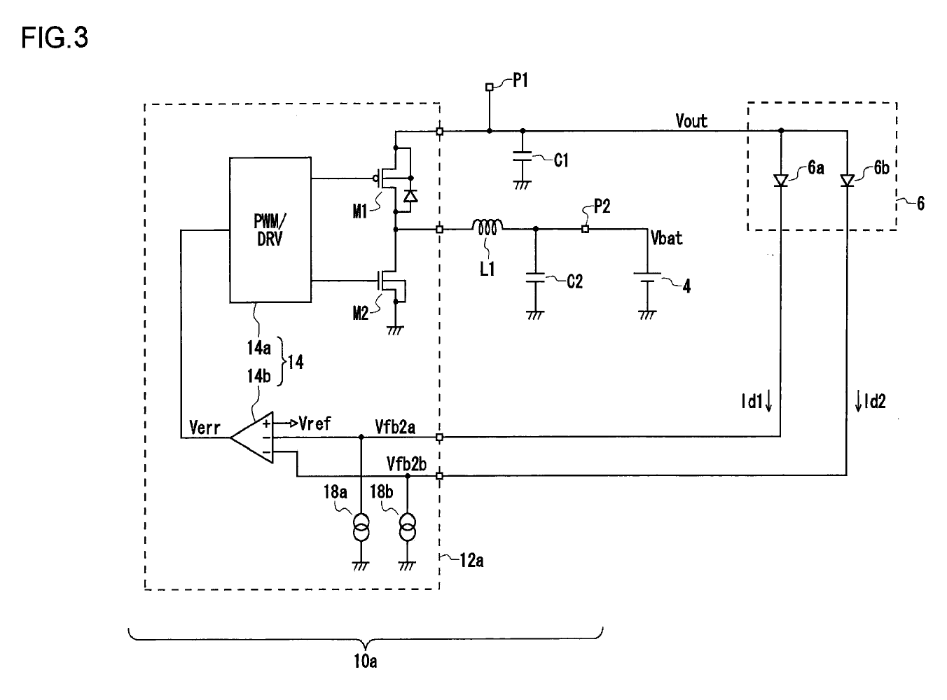

FIG. 3 is a block diagram of a driving device that drives a light emitting diode (LED) using the DC/DC converter 10 of FIG. 2. The load 6 includes a first LED 6a and a second LED 6b. The anodes of the LEDs 6a and 6b are commonly connected to the first terminal P1. In FIG. 3, only the circuit block related to the second mode is illustrated, and illustration of the block related to the first mode is omitted.

The charging control circuit 12a of the DC/DC converter 10a includes electric current sources 18a, 18b in addition to the first transistor M1 and the second transistor M2. The current source 18a is connected between the cathode of the LED 6a and the ground terminal, and the current source 18b is connected between the cathode of the LED 6b and the ground terminal. The current sources 18a, 18b respectively generate driving currents Id1, Id2 in accordance with the brightness of the corresponding LEDs 6a, 6b.

The control unit 14 includes a modulator/driver 14a and an error amplifier 14b. A reference voltage Vref is fed back to the non-inverting input terminal of the error amplifier 14b, and the respective cathode voltages of the LEDs 6a, 6b, namely the voltages Vfb2a, Vfb2b at both ends of the current sources 18a, 18b are fed back to the two inverting input terminals of the error amplifier 14b. The fed-back voltages Vfb2a, Vfb2b correspond to the amount of feedback by the second feedback path FB2 of FIG. 2.

The error amplifier 14b amplifies the error between the lower one of the fed-back voltages Vfb2a, Vfb2b and the reference voltage Vref. The amplified error voltage Verr is input into the modulator/driver 14a. The modulator/driver 14a generates a pulse signal having a duty ratio that accords to the error voltage Verr, and switches the second transistor M2 on the basis of the generated pulse signal. For example, the modulator may include an oscillator that generates a periodic voltage of a triangular wave or a saw-shaped wave and a PWM comparator that generates a pulse signal that undergoes transition of the level for each intersection by comparing and slicing the periodic voltage with the error voltage Verr. The driver drives the gates of the first transistor M1 and the second transistor M2 on the basis of the output of the PWM comparator.

According to the DC/DC converter 10a of FIG. 3, the feedback is carried out so that the lower one of the voltages of the current sources 18a, 18b will be equal to the reference voltage Vref. The reference voltage Vref is set to have a value such that the current sources 18a, 18b operate in a normal manner. In other words, according to the DC/DC converter 10a, the respective anode voltages (Vout) are adjusted so that the driving currents Id1, Id2 will flow stably through the LEDs 6a, 6b.

The above-described embodiments are merely an exemplification, and those skilled in the art will understand that various modifications can be made on the combination of those constituent elements and the treatment processes, and that those modifications are also included within the scope of the present invention. Hereafter, such modifications will be described.

In the embodiment, description has been made on a case in which the DC/DC converter 10 is operated as a step-up circuit for driving the load 6 and a charging circuit for charging the battery 4; however, the present invention is not limited thereto.

For example, in place of the battery 4, another power source may be provided. In this case, the DC/DC converter 10 operates as a down-step circuit that lowers the voltage of the external voltage Vext to supply the lowered voltage to the power source in the first mode and operates as a boost circuit that raises the voltage that is output from the power source to supply the raised voltage to the load 6 in the second mode.

In other words, the DC/DC converter 10 according to the embodiment can be applied to a variety of applications in which a power source and a load are connected to the first terminal P1 and the power source and the load are connected also to the second terminal P2. When a voltage is supplied to the first terminal P1, the second terminal P2 side will be the output (load), whereas when a voltage is supplied to the second terminal P2, the first terminal P1 side will be the output (load).

In FIG. 3, description has been made on a case in which the load 6 includes two LEDs; however, the number of LEDs is arbitrary. Further, the load 6 is not limited to the LEDs alone, so that an arbitrary circuit can be connected as a load. For example, the load 6 may be a liquid crystal driver or an organic EL driver. In this case, the voltage of the first terminal PI may be fed back to the control unit 14 in the second mode.

While the preferred embodiments of the present invention have been described using specific terms, such description is for illustrative purposes only, and it is to be understood that changes and variations may be made without departing from the spirit or scope of the appended claims.

What is claimed is:

1. A control circuit that controls a synchronized rectification type DC/DC converter in which a first voltage is supplied to a first terminal and a power source is connected to a second terminal,
the synchronized rectification type DC/DC converter comprising:
a first transistor and a second transistor that are disposed in series between the first terminal and a fixed voltage terminal;
an inductor that is disposed between the second terminal and a connection point of the first transistor and the second transistor; and
a capacitor that is disposed between the second terminal and the fixed voltage terminal,
wherein
the control circuit is configured to be capable of switching between:
a first mode in which the control circuit allows the first transistor and the second transistor to be alternately subjected to a switching operation, so as to lower the first voltage of the first terminal and to output the lowered voltage to the power source connected to the second terminal, and
a second mode in which the control circuit receives a voltage from the power source at the second terminal, turns the first transistor off, and allows the second transistor to be subjected to a switching operation, so as to raise the voltage of the power source and to output the raised voltage to the first terminal.

2. The control circuit according to claim 1, which operates in the first mode when the first voltage is supplied, and operates in the second mode when the first voltage is not supplied.

3. The control circuit according to claim 1, including a control terminal that receives an input of a control signal indicating the selection between the first and second modes.

4. The control circuit according to claim 1, wherein
the power source is a battery, and
the synchronized rectification type DC/DC converter functions as a charging circuit that charges the battery when the control circuit operates in the first mode.

5. An electronic apparatus comprising:
a battery;
a synchronized rectification type step-down DC/DC converter having an input terminal that receives an external voltage and an output terminal to which the battery is connected; and
a load connected to the input terminal of the step-down DC/DC converter,
wherein
the step-down DC/DC converter is configured to be capable of switching between:
a first mode in which the converter operates as a step-down type switching regulator to charge the battery with the external voltage, and
a second mode in which the converter operates as a step-up type switching regulator that raises a battery voltage of the output terminal to output the raised voltage to the input terminal, so as to drive the load.

6. The electronic apparatus according to claim 5, which drives the load with the external voltage in the first mode.

7. The electronic apparatus according to claim 5,
wherein
the load is a light emitting diode, and the electronic apparatus further includes a current source that is disposed on a path of the light emitting diode, and
the DC/DC converter performs a step-up operation by feedback so that a voltage across the current source will have a constant value in the second mode.

8. A DC/DC converter comprising:
first and second terminals;
a first transistor and a second transistor that are disposed in series between the first terminal and a fixed voltage terminal;
a diode that is disposed in parallel with the first transistor in a direction such that a cathode thereof will be on the first terminal side;
an inductor that is disposed between the second terminal and a connection point of the first transistor and the second transistor;
a first capacitor that is disposed between the first terminal and the fixed voltage terminal;
a second capacitor that is disposed between the second terminal and the fixed voltage terminal; and
a control unit that controls a state of the first and second transistors,
wherein
the control unit is configured to be capable of switching between:
a first mode in which the control unit allows the first transistor and the second transistor to be alternately subjected to a switching operation, so as to lower an external voltage of the first terminal and to output the lowered voltage to the second terminal, and
a second mode in which the control unit turns the first transistor off, and allows the second transistor to be subjected to a switching operation, so as to raise a voltage that is input to the second terminal and to output the raised voltage to the first terminal.
